(19) United States
(12) Patent Application Publication
(10) Pub. No.: US 2012/0116784 A1
(43) Pub. Date: May 10, 2012

(54) System and Method for Recording, Processing and Storing Citations

(75) Inventors: Jeremy Keith Mattern, Austin, TX (US); Richard Ezzeddine, Houston, TX (US)

(73) Assignee: IBERON, LLC, Houston, TX (US)

(21) Appl. No.: 12/940,460

(22) Filed: Nov. 5, 2010

(51) Int. Cl. G06Q 10/00

(52) U.S. Cl. 705/1.1

(57) ABSTRACT

A method and system for processing a citation are disclosed. Specifically, a method for processing a citation can include receiving from a mobile citation device a citation record related to a citation issued to a violator. Further, a citation, comprising at least a portion of the citation record and fields to be completed by the Supervisor can be sent to a Supervisor of the violator. Further, the citation completed by the Supervisor can be received and information in the fields completed by the Supervisor can be captured.

### BACKGROUND

This disclosure relates to a system and method for electronic citation and citation adjudication. More particularly, this disclosure relates to populating an electronic citation and delivering the citation for disposition.

For violations of codes, authorities can issue citations to alleged offenders. For example, a civilian police officer might issue a citation to a motorist if the officer sees the motorist failing to stop at a stop sign. On federal and military installations, similar citations can be issued. As an example, an Armed Forces Traffic Ticket (such as a DD Form 1408), or equivalent, is a citation issued for minor infractions, such as talking on a cellular phone while driving, speeding, or failing to stop at a stop sign. Commanding officers and civilian Supervisors (hereinafter referred to as “Supervisor”) are the deciding authority on Armed Forces Traffic Tickets, not a Federal Magistrate. Once the Supervisor has rendered a decision, the Supervisor communicates his decision with records personnel for record keeping and enforcement. Penalties from Armed Forces Traffic Tickets are assessed by Supervisor, which can include traffic points and suspended driving privileges, among other things.

Present citation methods include officers stopping violators and filling out violation information on a carbon paper citation. One copy of the paper citation is delivered to the violator's Supervisor, a second copy is given to the violator, and a third copy is kept by the officer. The Supervisor can then review the citation and, after making proper notations on the citation regarding the manner of the dispositions, can deliver a copy to records personnel.

However, there are a number of problems associated with paper citations. First, officer handwriting can often be illegible. Second, if a paper citation must go to many people, either a copy must be made for each person, or a shared copy must be sent to each person. Third, carbon copies are often difficult to read if the officer does not write with sufficient force. Fourth, paper copies can be lost, either in delivery or by the recipient. Last, notes typically cannot be added later to paper citations. It would, therefore, be advantageous to implement an improved method and system for creating, processing, and storing citations.

### SUMMARY

A method and system for creating, processing, and storing a citation are disclosed. Specifically, the method can include receiving from a mobile citation device a citation record related to a citation issued to a violator. Further, a paper or electronic citation, comprising at least a portion of the citation record and fields to be completed by the Supervisor can be sent to a Supervisor of the violator. Further, the citation completed by the Supervisor can be received and information in the fields completed by the Supervisor can be captured.

A server that receives a citation record from a mobile citation device is disclosed. Specifically, a citation record can be received from a mobile citation device, wherein the citation record is related to a citation issued to a violator. Further, the server can cause a paper or electronic citation to be sent to a Supervisor of the violator, wherein the citation comprises at least a portion of the citation record. The citation can comprise fields to be completed by the Supervisor.

### BRIEF DESCRIPTION OF THE DRAWINGS

FIG. 1 illustrates a citation management system.

FIG. 2 illustrates input and output hardware on a mobile citation device.

FIG. 3 illustrates internal hardware within a mobile citation device.

FIG. 4 illustrates a mobile citation device screen shot.

FIG. 5 illustrates data flow between mobile citation device and server.

FIG. 6 illustrates data flow between server and a citation officer computer.

FIG. 7 illustrates a screen shot of citation officer computer displaying citation officer citation list.

FIG. 8 illustrates a screen shot of citation officer computer displaying citation officer notes.

FIG. 9 illustrates a screen shot of citation officer computer displaying available citation approvers.

FIG. 10 illustrates data flow between server and citation approver computer.

FIG. 11 illustrates a screen shot of citation approver computer displaying citation approver citation list.

FIG. 12 illustrates a screen shot of citation approver computer displaying citation approver notes.

FIG. 13 illustrates a screen shot of citation approver computer displaying available records personnel.

FIG. 14 illustrates data flow between server and records personnel computer.

FIG. 15 illustrates a screen shot of records personnel computer displaying records personnel citation list.

FIG. 16 illustrates a screen shot of records personnel computer displaying records personnel notes.

FIG. 17 illustrates a screen shot of records personnel computer displaying a Supervisor search tool.

FIG. 18 illustrates a printed citation.

FIG. 19 illustrates a screenshot of records personnel computer displaying Supervisor notes entry.

FIG. 20 illustrates a preferred embodiment for recording, processing, and storing a citation.

### DETAILED DESCRIPTION

Described herein is an improved method for creating, processing, and storing an electronic citation. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), numerous programming decisions must be made to achieve the developers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of database design and management having the benefit of this disclosure. Accordingly, the claims appended hereto are not intended to be limited by the disclosed embodiments, but are to be accorded their widest scope consistent with the principles and features disclosed herein.

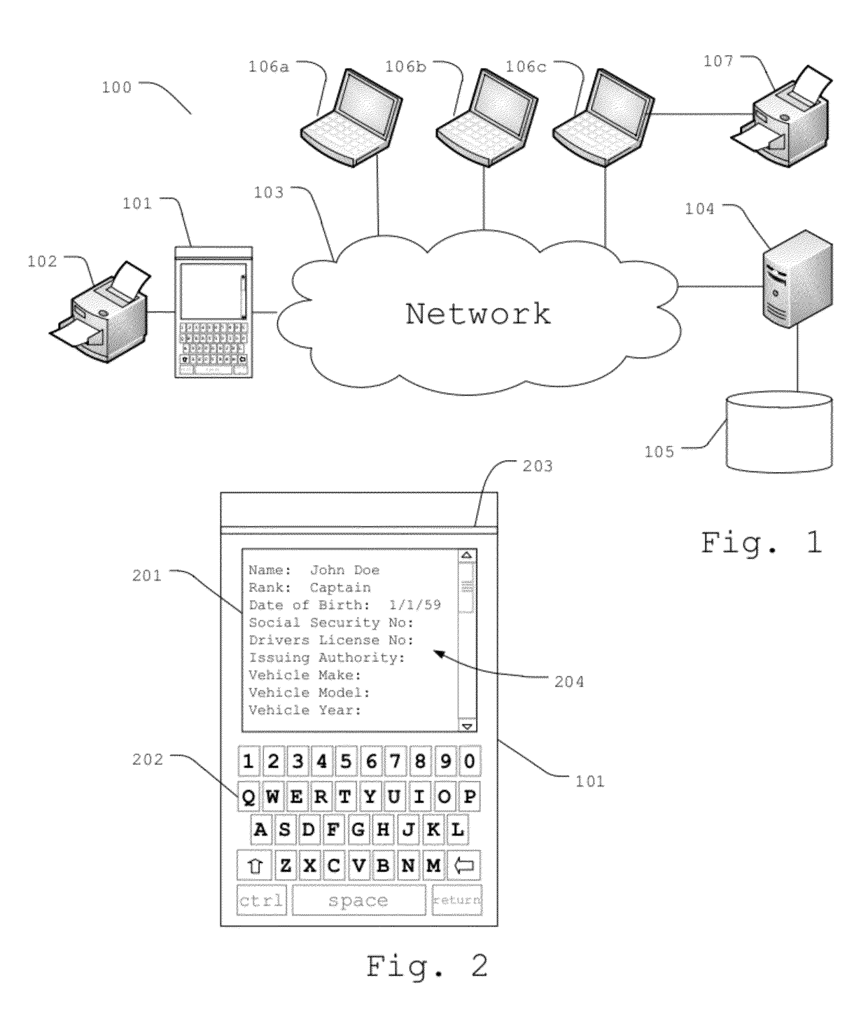

FIG. 1 illustrates a citation management system 100. Citation management system 100 can comprise a mobile citation device 101 that can capture citation data at or near the location of a violation. Within citation management system 100, there can exist many mobile citation devices 101, each associated with a different user. Mobile citation device 101 can connect to a printer 102. Mobile citation device 101 can also connect to a network 103, which can connect to a server 104. In one embodiment, as shown in FIG. 1, printer 102 can be hardwired to mobile citation device 101. In another embodiment, printer 102 can connect to mobile citation device via a localized network, such as a piconet. In another embodiment, printer 102 can be a component of mobile citation device 101. Network 103 can be a local area network (LAN), a wide area network (WAN), a piconet, or a combination of LANs, WANs, or piconets. One illustrative LAN is a network within a single business. One illustrative WAN is the Internet. Server 104 represents at least one, but can be many servers, each connected to network 103. Server 104 can connect to a storage device 105. Storage device 105 can connect directly to server 104, as shown in FIG. 1, or may exist remotely on network 103. Storage device 105 can comprise any suitable long-term or persistent storage device and, further, may be separate devices or the same device and may be collocated or distributed (interconnected via any suitable communications network). Citation management system 100 can also include one or more computers 106, connected to the network. Computers 106 each can include, but is not limited to, a laptop, desktop, workstation, server, mainframe, terminal, and/or mobile citation device 101.

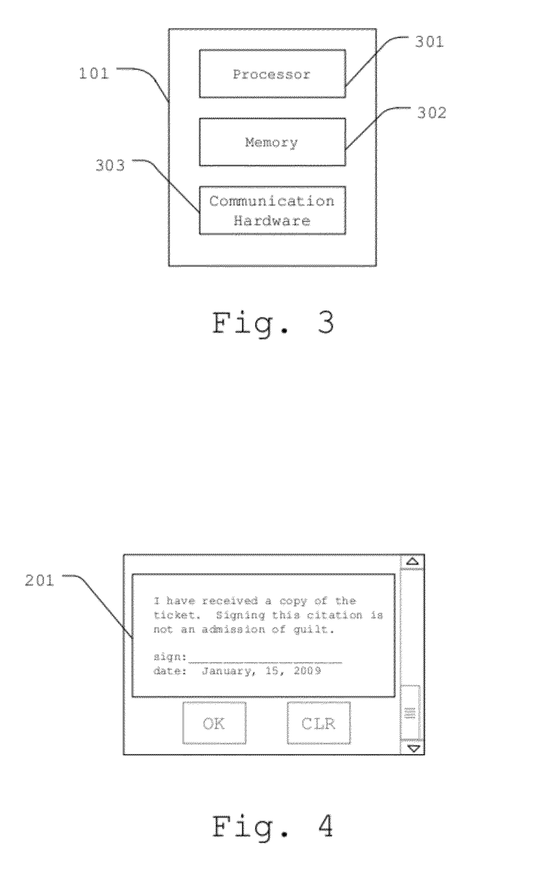

FIG. 2 illustrates input and output devices on mobile citation device 101. Mobile citation device 101 can include, but is not limited to, a screen 201, a keypad 202, and a card reader 203. Other input devices can include track balls, joy sticks, or scroll wheels. Input data 204 can include but is not limited to, a violator's name, violator's offenses, military rank, serial number, grade, military organization, military installation, and/or an identity of a Supervisor. Keypad 202 can comprise a plurality of physical buttons on mobile citation device 101; however, in an embodiment wherein screen 201 is a touch screen, keypad 202 can be represented virtually on screen 201. Card reader 203 can read information from an identification card. An identification card can encode information in various ways. Information can be printed on the information card. Also, information can be placed on the card in a machine-readable form. Such forms can include magnetic strip, barcode, or even radio frequency identification (RFID) chip. An identification card can include, but is not limited to, a civilian or military driver's license, a passport, a school identification badge, or a credit card. In one embodiment, card reader 203 can read a magnetic strip on an identification card. In another embodiment, card reader 203 can read information encoded in a barcode on an identification card. In another embodiment, card reader 203 comprises a (RFID) chip receiver to read an RFID chip in an identification card.

FIG. 3 illustrates internal hardware within mobile citation device 101. Input data 204 from screen 201, keypad 202, and/or card reader 203 is sent to a processor 301. Processor 301 can perform processes on the data according to an application stored in a memory 302, as discussed further below. Processes can include storing input data 204 to memory 302, verifying input data 204 conforms to preset standards, or ensuring all required data has been gathered for a citation to be complete. For purposes of this disclosure, input data 204 can include data which mobile citation device 101 may populate automatically, such as date and time, as well as data entered manually. Once a citation is complete, an on-site citation record can be sent to communication hardware 303 for communication over network 103. Communication hardware 303 can include a network transport processor for packetizing data, communication ports for wired communication, or an antenna for wireless communication.

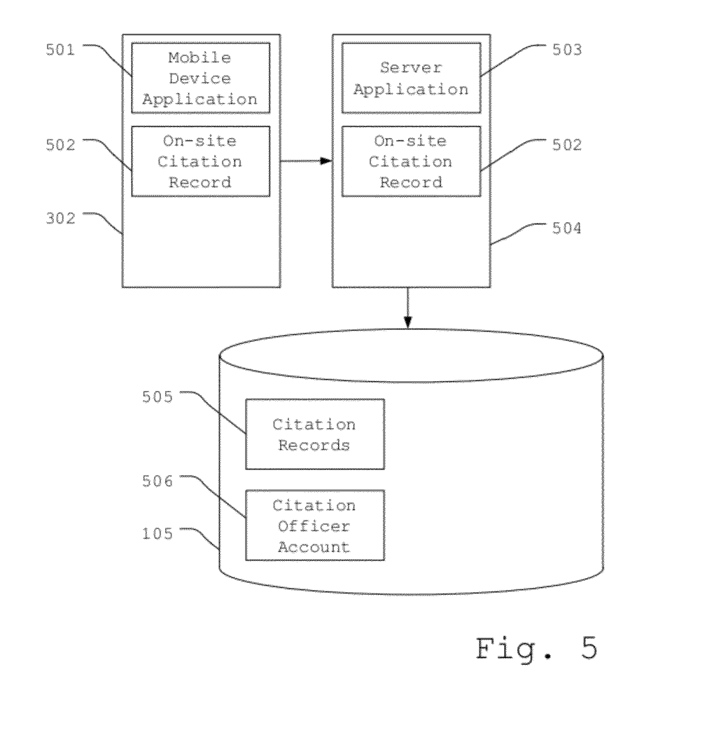

FIG. 4 illustrates screen 201. Screen 201 can be a mere display output, or can also be a touch screen, allowing for capturing of input data 204. In some jurisdictions, it may be necessary to obtain a signature from a violator. In one embodiment, screen 201 can be used as an input device using a stylus. Using the stylus, a violator can sign his name on screen 201. Screen 201 can then capture the signature as an image to store with other citation data.

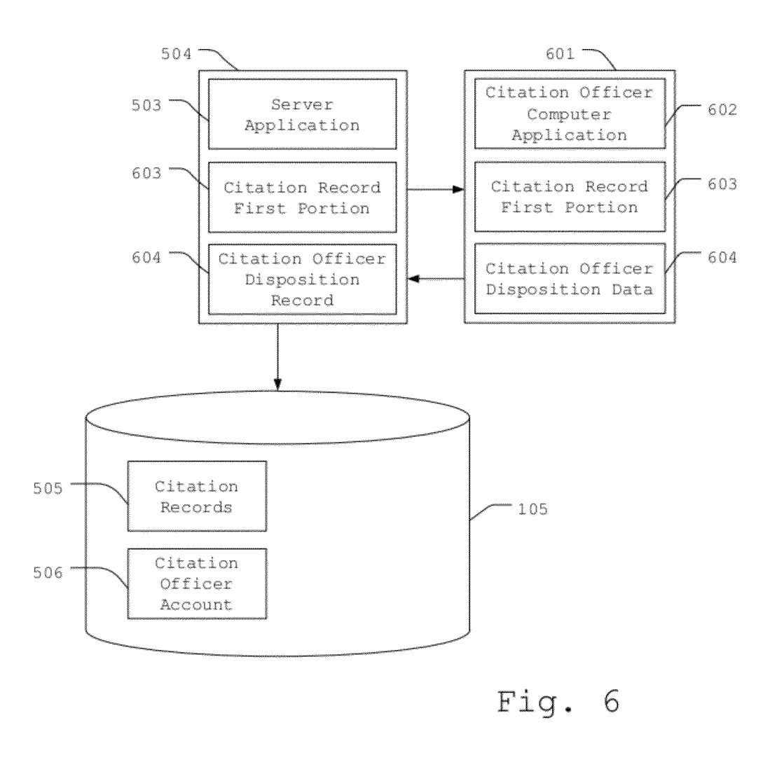

FIG. 5 illustrates data flow between mobile citation device 101 and server 104 during citation recording, processing, and storing. A citation officer, using mobile citation device 101, can capture input data 204. Executing a mobile device application 501 stored in memory 302, mobile citation device 101 can display a series of data input fields capable of accepting input data 204 from the citation officer. Further mobile device application 501 can display input data 204 to screen, store input data 204 in memory 302, and/or transmit input data 204 to server 104. Further, in one embodiment, mobile device application 501 can process at least a portion of input data 204 to form an on-site citation record 502. In such embodiment, on-site citation record 502 can be sent to server 104. On-site citation is a record of one or more issued citations. For purposes of this disclosure, citations can include citations for infractions and/or warnings for infractions. In one embodiment, mobile device application 501 can be a browser application. Further, mobile device application 501 can be used to access a web-based application, as described below. At least a portion of input data 204 can be sent to server 104 where a server application 503 can exist in a server address space 504. In one embodiment, server application 503 can form on-site citation record 502. On-site citation records can be distinguished using unique identifiers, which are described in patent application Ser. No. 12/648,850, titled Electronic Citation Recording, Processing and Storing, which is hereby incorporated by reference. Server application 503 can perform various tasks including verifying that on-site citation record 502 is complete, storing on-site citation record 502 in a citation record 505 in storage device 105. In one embodiment, storage device 105 can be a portion of server address space 504. Server application 503 can associate citation record 505 with a citation officer account 506. In one embodiment, server application 503 is a web-based application capable of being accessed by users on network 103. See infra.

FIG. 6 illustrates data flow between server 104 and a citation officer computer 106a. Computer 106a can comprise an address space 601 that further comprises a citation officer application 602. In one embodiment, citation officer application 602 is a web browser. In one embodiment, citation officer application 602 can interface with server application 503 to let citation officer log into citation officer account 506. In one embodiment, once logged into citation officer account 506, citation officer can access a citation record first portion 603 associated with his citation officer account 506, as discussed below. Citation record first portion 603 can be all or a part of citation record 505. Citation officer application 602 can transmit to server application 503 a citation officer disposition data 604. See Infra. In one embodiment, citation officer disposition data 604 can be added to citation record 505.

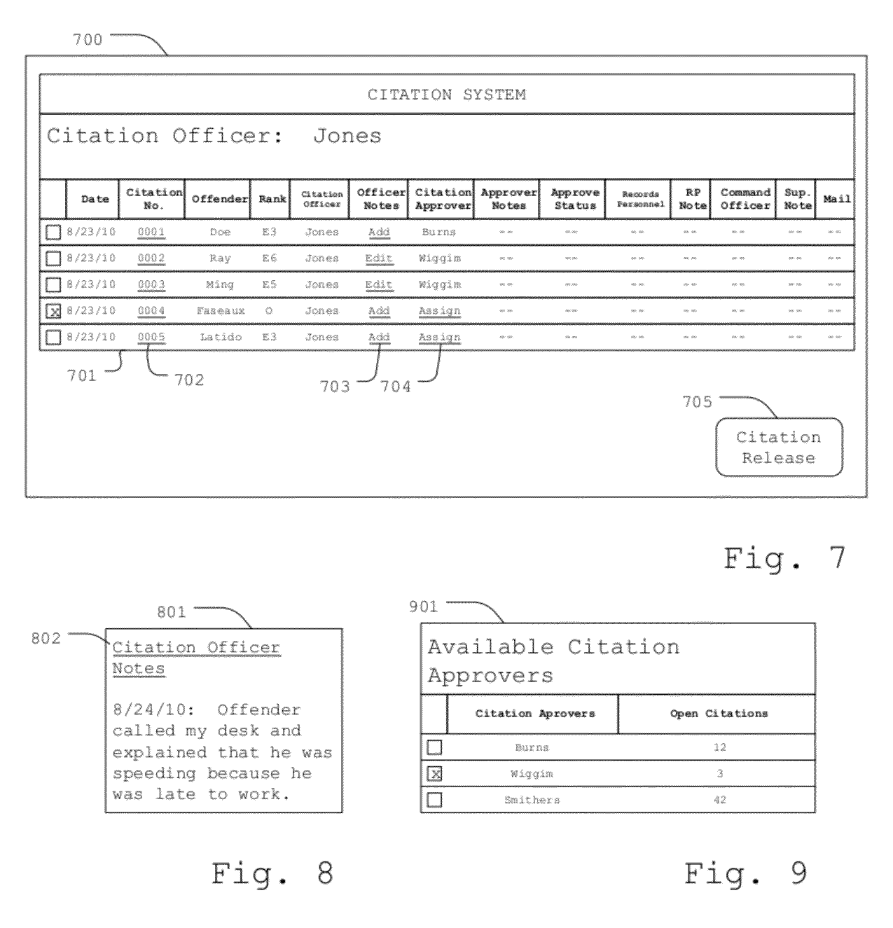

FIG. 7 illustrates a screen shot of citation officer computer displaying citation officer citation list. Once logged into his account, the citation officer can view citation officer screen 700. Citation officer screen 700 can comprise citation officer citation listings 701, each associated with a particular citation record 505. Using selectors that include but are not limited to buttons, check boxes, and links, citation officer can choose a particular citation record 505. In one embodiment, each citation officer citation listing 701 can comprise a citation view selector 702, a citation officer notes selector 703, and/or citation approver selector 704. In one embodiment, citation officer can view citation record first portion 603 by clicking citation officer notes selector 703. In one embodiment, citation officer screen 700 can also comprise a citation officer citation release button 705.

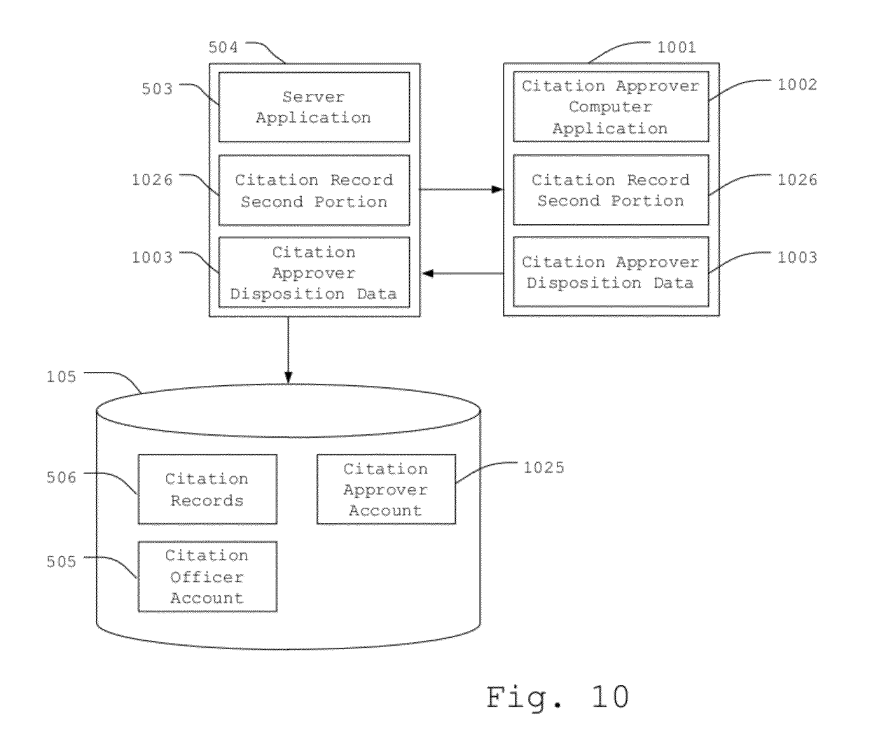

FIG. 8 illustrates a screen shot of citation officer computer displaying citation officer notes. In an embodiment wherein citation officer citation listing 701 comprises a citation officer notes selector 703, citation officer notes selector 703 can open a text input box 801 whereby citation officer can add a citation officer notes 802. Citation officer computer application 602 can transmit citation officer notes 802 to server application 503 as a portion of citation officer disposition data 604.

FIG. 9 illustrates a screen shot of citation officer computer displaying available citation approvers. In one embodiment, citation officer can choose a specific citation approver to assign to a citation. In such embodiment, citation approver selector 704 can let citation officer choose a citation approver. In one embodiment, a dialogue box 901 can open. In another embodiment, a pull down menu can appear. In one embodiment, choosing a citation approver causes citation to be visible by citation approver, as is described further below. In another embodiment, citation officer must take an additional step of clicking citation release button 705. In still another embodiment, citation officer can be his own citation approver. In one embodiment, when citation officer chooses a citation approver, such selection can be transmitted to server application 503 as a portion of citation officer disposition data. In one embodiment, citation officer disposition data 604 is transmitted as an entire block of data. In another embodiment, citation officer disposition data 604 is transmitted in portions.

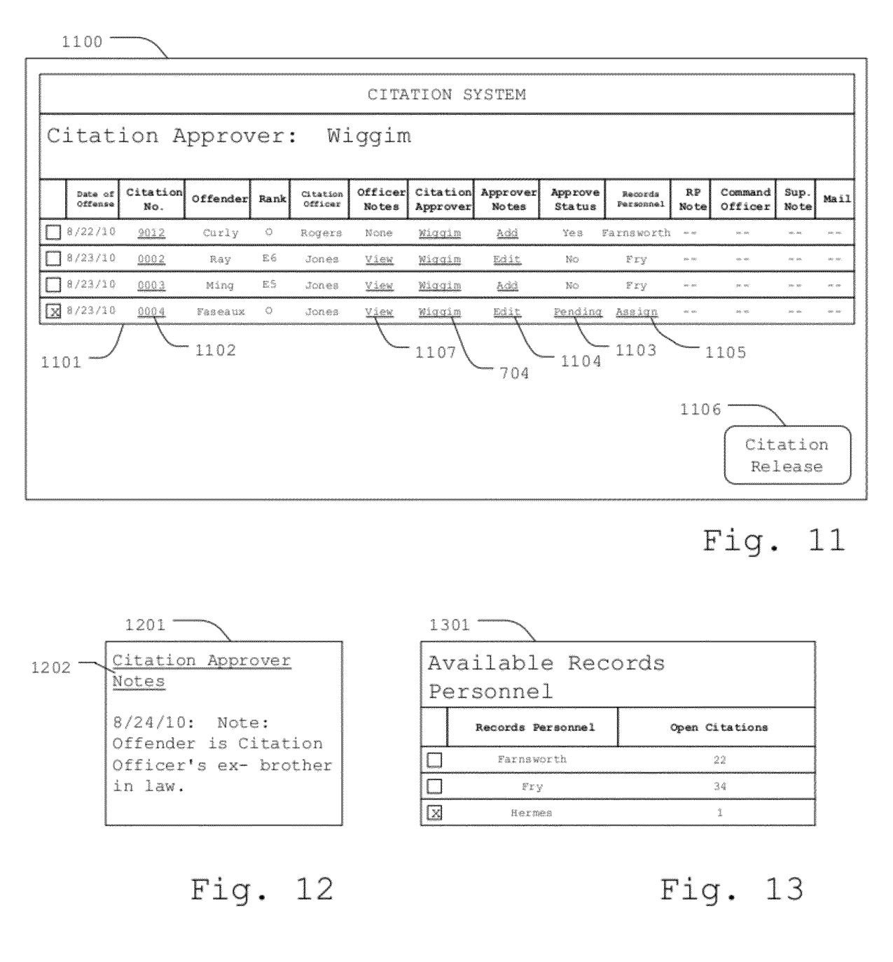

FIG. 10 illustrates data flow between server 104 and citation approver computer 106b. Computer 106b can comprise a citation approver address space 1001 that further comprises a citation approver application 1002. In one embodiment, citation approver application 1002 is a web browser. In one embodiment, citation approver application 1002 can interface with server application 503 to let citation approver log into citation approver account 1025. In one embodiment, once logged into citation approver account 1025, citation approver can access a citation record second portion 1026 associated with his citation approver account 1025, as discussed below. Citation record second portion 1026 can be all or a part of citation record 505. Citation approver application 1002 can transmit to server application a citation approver disposition data 1003. See Infra. In one embodiment, citation approver disposition data 1003 can be added to citation record 505.

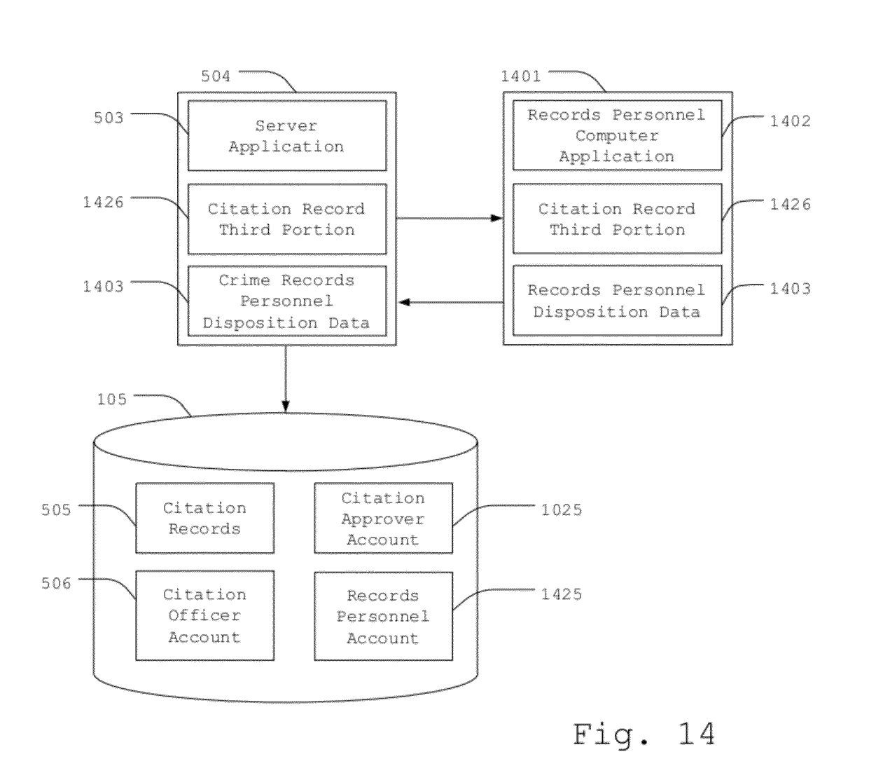

FIG. 11 illustrates a screen shot of citation approver computer displaying citation approver citation list. Once logged into his account, the citation approver can view citation approver screen 1100. Citation approver screen 1100 can comprise citation approver citation listings 1101, each associated with a particular citation record 505. Using selectors that include but are not limited to buttons, check boxes, and links, citation approver can choose a particular citation record 505. In one embodiment, each citation approver citation listing 1101 can comprise a citation approver citation view selector 1102, an approval status selector 1103, a citation approver notes selector 1104, and/or records personnel selector 1105. In one embodiment, citation approver can view citation record second portion 1026 by clicking citation approver citation view selector 1102. In one embodiment, approval status selector 1103 can be a plurality of buttons. For example, approval status selector 1103 can comprise an approve and a reject button. Using approval status selector 1103, citation approver can approve or reject the citation associated with citation record 505. In one embodiment, citation approver screen 1100 can also comprise a citation approver citation release button 1106. In one embodiment, citation approver citation listings 1101 can also comprise a citation officer notes view selector 1107. In such embodiment, citation approver can view citation officer notes by clicking on citation officer notes view selector 1107. In one embodiment, citation approver citation listings 1101 can comprise citation approver selector 704. In such embodiment, citation approver can use citation approver selector to reassign citation approver citation listing 1101 to a different citation approver.

FIG. 12 illustrates a screen shot of citation approver computer displaying citation approver notes. In an embodiment wherein citation approver citation listing 1101 comprises a citation approver notes selector 1104, citation approver notes selector 1104 can open a citation approver text input box 1201 whereby citation approver can add a citation approver notes 1202. Citation approver computer application 1002 can transmit citation approver notes 1202 to server application 503 as a portion of citation approver disposition data 1003.

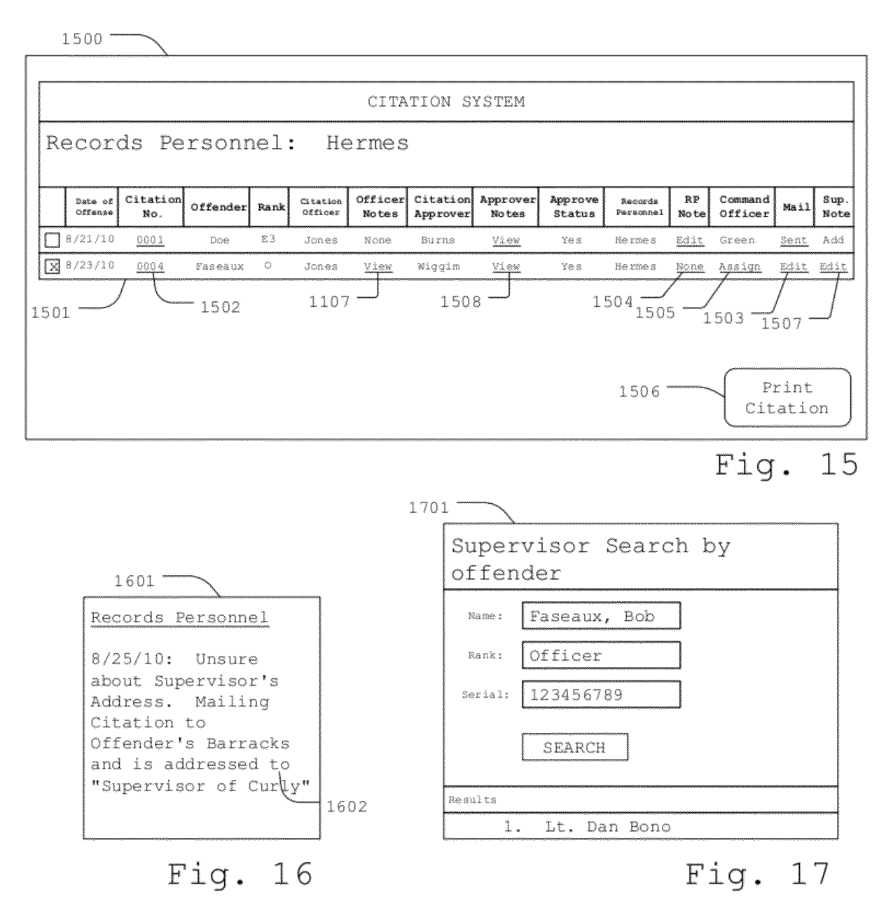

FIG. 13 illustrates a screen shot of citation approver computer displaying available records personnel. In one embodiment, citation approver can choose a specific records personnel to assign to a citation. In such embodiment, records personnel selector 1105 can let citation approver choose a records personnel. In one embodiment, a dialogue box 1301 can open. In another embodiment, a pull down menu can appear. In one embodiment, choosing records personnel causes citation to be visible by records personnel, as is described further below. In another embodiment, citation approver must take an additional step of clicking citation approver citation release button 1106. In still another embodiment, citation approver disposition data 1003 can be automatically sent to one or more records personnel when citation approver approves or completes reviewing citation record 505. In one embodiment, when citation approver chooses records personnel, such selection can be transmitted to server application 503 as a portion of citation approver disposition data 1003. In one embodiment, citation approver disposition data 1003 is transmitted as an entire block of data. In another embodiment, citation approver disposition data 1003 is transmitted in portions.

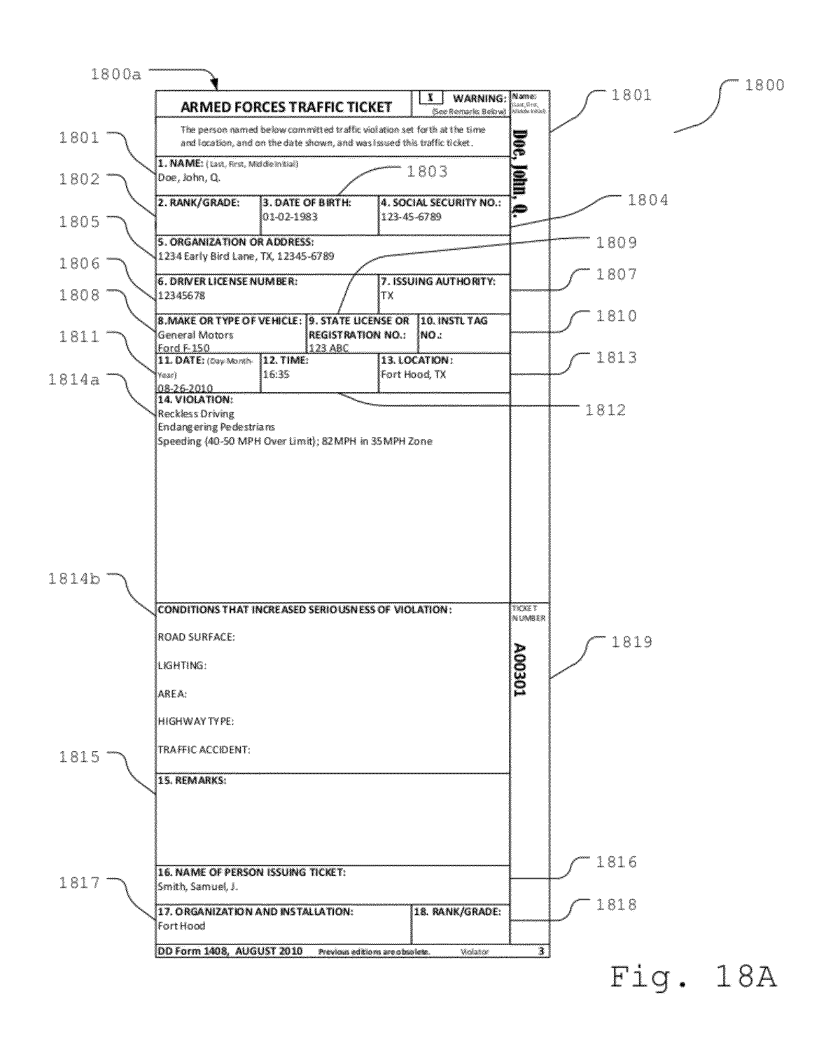

FIG. 14 illustrates data flow between server 104 and records personnel computer 106c. Computer 106c can comprise a records personnel address space 1401 that further comprises a records personnel application 1402. In one embodiment, records personnel application 1402 is a web browser. In one embodiment, records personnel application 1402 can interface with server application 503 to let records personnel log into records personnel account 1425. In one embodiment, once logged into records personnel account 1425, records personnel can access a citation record third portion 1426 associated with his records personnel account 1425, as discussed below. Citation record third portion 1426 can be all or a part of citation record 505. Records personnel application 1402 can transmit to server application a records personnel disposition data 1403. See Infra. In one embodiment, records personnel disposition data 1403 can be added to citation record 505.

FIG. 15 illustrates a screen shot of records personnel computer 106c displaying records personnel citation list. Once logged into records personnel account 1425, the records personnel can view records personnel screen 1500. Records personnel screen 1500 can comprise records personnel citation listings 1501, each associated with a particular citation record 505. Using selectors that include but are not limited to buttons, check boxes, and links, records personnel can choose a particular citation record 505. In one embodiment, each records personnel citation listing 1501 can comprise a records personnel citation view selector 1502, a mail status selector 1503, a records personnel notes selector 1504, Supervisor selector 1505, a print citation selector 1506, and/or a Supervisor notes selector 1507. In one embodiment, records personnel can view citation record third portion 1426 by clicking records personnel citation view selector 1502. In one embodiment, mail status selector 1503 can be a plurality of buttons. For example, mail status selector 1503 can comprise unsent, sent, and/or received buttons. In another embodiment, mail status selector 1503 can be a drop down menu. Citations can be sent to and from the Supervisor in a number of ways including, but not limited to fax, email, and/or letter carrier. Using mail status selector 1503, records personnel can communicate to server 104. In one embodiment, records personnel citation listings 1501 can also comprise a citation officer notes view selector 1107. In such embodiment, records personnel can view citation officer notes by clicking on citation officer notes view selector 1107. In one embodiment, records personnel citation listings 1501 can also comprise a citation approver notes view selector 1508. In such embodiment, records personnel can view citation approver notes by clicking on citation approver notes view selector 1508. In one embodiment, records personnel citation listings 1501 can comprise records personnel selector 1105. In such embodiment, records personnel can use records personnel selector 1105 to reassign records personnel citation listing 1501 to a different records personnel.

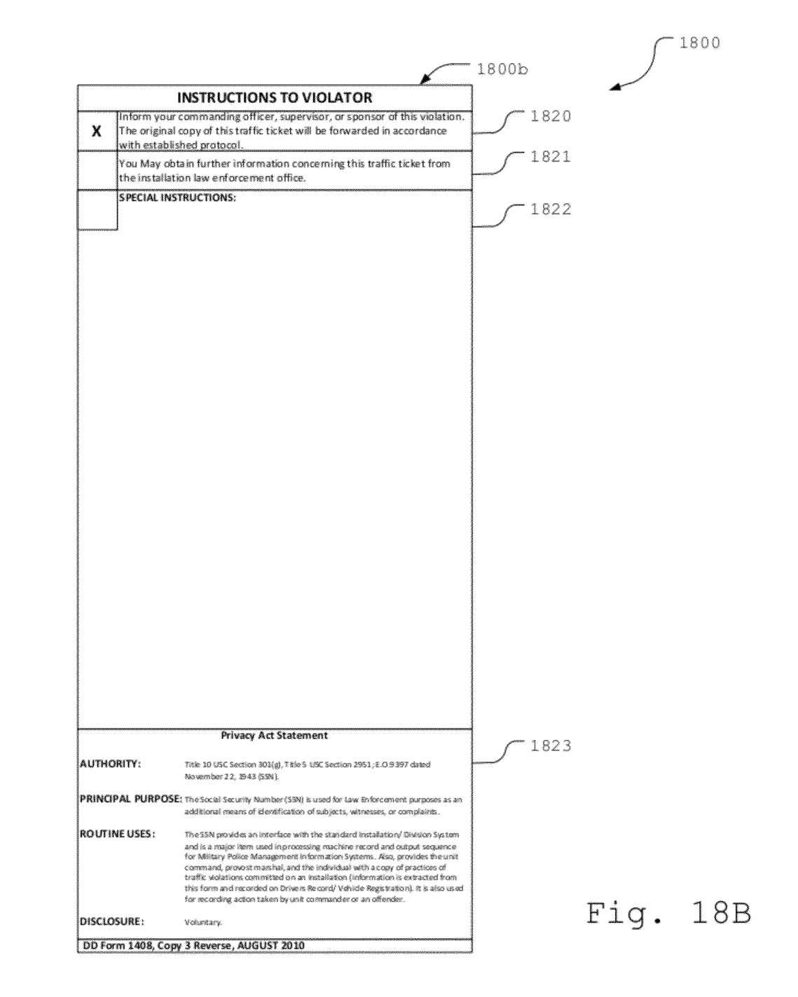

FIG. 16 illustrates a screen shot of records personnel computer 106c displaying records personnel notes 1602. In an embodiment wherein records personnel citation listing 1501 comprises a records personnel notes selector 1504, records personnel notes selector 1504 can open a records personnel text input box 1601 whereby records personnel can add a records personnel notes 1602. Records personnel computer application 1402 can transmit records personnel notes 1602 to server application 503 as a portion of records personnel disposition data 1403.

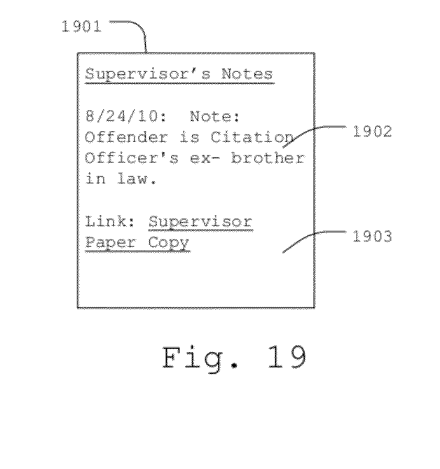

FIG. 17 illustrates a screen shot of records personnel computer displaying a Supervisor search tool. In one embodiment, records personnel can choose a Supervisor to whom the citation will be sent. In such embodiment, Supervisor selector 1505 can let records personnel choose a Supervisor. In one embodiment, a Supervisor dialogue box 1701 can open. In another embodiment, a pull down menu can appear. In one embodiment, records personnel can search for Supervisors. Such search criteria can include, but is not limited to, violator name, rank, and/or serial number. In another embodiment, records personnel can supply the identity of Supervisor without choosing from an electronic list, simply by keying in the Supervisor's name. In one embodiment, choosing a Supervisor sends an electronic copy of a portion of citation record to Supervisor. In another embodiment, records personnel can print a Supervisor citation copy, an enforcement officer copy, and/or a violator copy using printer 107. In such embodiment, one or more of the paper copies can be mailed to Supervisor. Such mailing can be automated, or can be done by hand. In another embodiment, records personnel can transmit a request to server 104 to send an electronic citation record to Supervisor. Such process of server sent requests is described in patent application Ser. No. 12/648,850.

In one embodiment, when records personnel chooses Supervisor, such selection can be transmitted to server application 503 as a portion of records personnel disposition data 1403. In one embodiment, records personnel disposition data 1403 is transmitted as an entire block of data. In another embodiment, records personnel disposition data 1403 is transmitted in portions.

FIG. 18 illustrates an exemplary citation 1800. One example of an exemplary citation 1800 is a United States District Court Violation Notice. Another example is an Armed Forces Traffic Ticket, such as the DD Form 1408. FIG. 18A illustrates an exemplary citation front side 1800a. FIG. 18B illustrates an exemplary citation rear side 1800b. In one embodiment, front side 1800a and rear side 1800b can be printed on the same side of one sheet of paper. In another embodiment, front side 1800a and rear side 1800b can be printed on separate sheets of paper. Exemplary citation 1800 can comprise, several fields including, but not limited to, a name field 1801, a rank field 1802, a date of birth field 1803, a social security number field 1804, an organization-address field 1805, a driver license number field 1806, an issuing authority field 1807, a vehicle make field 1808, a state license/registration authority field 1809, a tag number field 1810, a date of offense field 1811, a time field 1812, a location field 1813, a violations field 1814a, a seriousness factors field 1814b, a remarks field 1815, an issuing person field 1816, an organization-installation field 1817, a rank-grade field 1818, a ticket number field 1819, an inform Supervisor field 1820, a further information directive field 1821, and/or a special instructions field 1822. Fields can be distributed between front portion 1800a and rear portion 1800b. Portions of citation record 505 can correspond to the fields on exemplary citation 1800. In such embodiment, portions of citation record 505 can be printed on exemplary citation 1800. Supervisor citation copy, an enforcement officer copy, and/or a violator copy can vary in what fields each comprises. For example, in one embodiment, a violator copy will not comprise further information directive field 1821, but Supervisor citation copy could comprise such field.

FIG. 19 illustrates a screenshot of records personnel computer displaying Supervisor notes entry. In one embodiment, upon sending a copy of citation to Supervisor, records personnel can wait for Supervisor to review, fill out, and return paper citation, either electronically or on paper. In an embodiment wherein citation is sent and returned on paper, records personnel can add Supervisor's additions to citation record 505 by clicking Supervisor notes selector 1507. By doing so, a Supervisor notes selector 1507 can open a records personnel text input box 1901 whereby records personnel can add a Supervisor notes 1902. Supervisor notes can comprise a scanned paper copy citation 1903 returned by Supervisor. Records personnel computer application 1402 can transmit Supervisor notes to server application 503 as a portion of records personnel disposition data 1403.

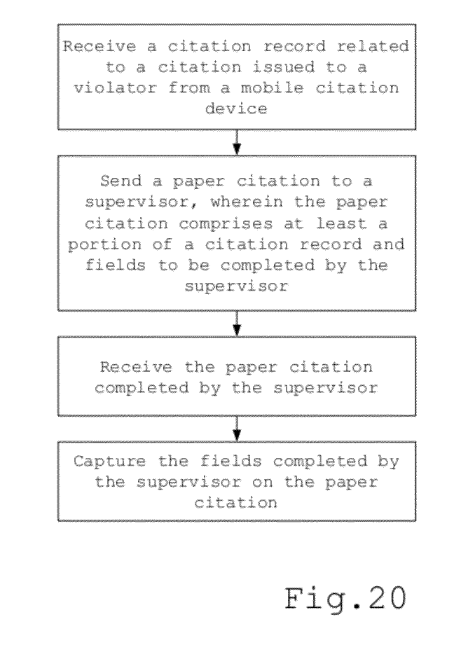

FIG. 20 illustrates a preferred embodiment for recording, processing, and storing a citation. Such method includes receiving a citation record, related to a citation issued to a violator, from a mobile citation device. Further, a paper citation, comprising at least a portion of the citation record and fields to be completed by the Supervisor, is sent to a Supervisor of the violator. Further, the paper citation completed by the Supervisor is received and information in the fields completed by the Supervisor are captured.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”.
A method for processing a citation comprising;
receiving a citation record from a mobile citation device, wherein the citation record is related to a citation issued to a violator;
sending citation record that comprises at least a portion of the citation record to a Supervisor of the violator, wherein the paper citation record comprises fields to be completed by the Supervisor;
receiving the citation record completed by the Supervisor; and
capturing information in the fields completed by the Supervisor.

2. The method of claim 1 wherein the citation is a federal or military issued citation.

3. The method of claim 2 wherein the citation is issued on an Armed Forces Traffic Ticket form.

4. The method of claim 2 wherein the citation is issued on a United States District Court Violation Notice form.

5. The method of claim 1 wherein the citation record is sent by fax.

6. The method of claim 1 wherein the citation record is sent in a printable email.

7. The method of claim 1 wherein the citation record is printed and mailed by carrier.

8. The method of claim 1 wherein the citation record completed by the Supervisor is received by fax.

9. The method of claim 1 wherein the citation record completed by the Supervisor is received electronically.

10. The method of claim 1 wherein the citation record completed by the Supervisor is received by mail carrier.

11. A server that receives a citation record from a mobile citation device, wherein the citation record is related to a citation issued to a violator;
causes a paper citation record to be sent to a Supervisor of the violator, wherein the paper citation record comprises at least a portion of the citation record, further wherein the paper citation record comprises fields to be completed by the Supervisor; and
receives information written in the fields completed by the Supervisor.

12. The server of claim 11 wherein the citation is a federal or military issued citation.

13. The server of claim 12 wherein the citation is issued on an Armed Forces Traffic Ticket form.

14. The server of claim 12 wherein the citation is issued on a United States District Court Violation Notice form.

15. As system for processing a citation comprising
a network;
a server that receives a citation record from a mobile citation device, wherein the citation record is related to a citation issued to a violator; and
a records personnel computer that
receives from a server at least a portion of the citation record;
causes a citation record to be sent to a Supervisor of the violator, wherein the citation record comprises the portion of the citation record, further wherein the citation record comprises fields to be completed by the Supervisor.

16. The server of claim 15, wherein the citation is a federal or military issued citation.

17. The server of claim 16 wherein the citation is issued on an Armed Forces Traffic Ticket form.

18. The server of claim 16 wherein the citation is issued on a United States District Court Violation Notice form.

19. The method of claim of claim 3 wherein the Armed Forces Traffic Form is a Department of Defense Form 1408.

20. The system of claim of claim 13 wherein the Armed Forces Traffic Form is a Department of Defense Form 1408.
